(19) United States
(12) Patent Application Publication
(10) Pub. No.: US 2018/0259984 A1
(43) Pub. Date: Sep. 13, 2018

(54) System for Supplying a Regulatable Inflow Fitting, and a Method for Filling the System

(71) Applicant: Kendrion Kuhnke Automation GmbH, Malente (DE)

(72) Inventors: Thomas KEMKOWSKI, Braak (DE); Frank MELZER, Eutin (DE)

(21) Appl. No.: 15/667,758

(22) Filed: Aug. 3, 2017

(30) Foreign Application Priority Data
Mar. 13, 2017 (EP) 17 160 490.3

(51) Int. Cl. G05D 23/13; E03C 1/04

(52) U.S. Cl. CPC G05D 23/1313; F16K 19/006; E03C 1/04

(57) ABSTRACT

A system for supplying a regulatable inflow fitting, a vehicle with such a system, and a method for filling such a system. The system for supplying the regulatable inflow fitting with temperature-controlled water includes a cold water feed, a water heater, a bypass line and a mixing valve. At an input side, the water heater is connected to the cold water feed. At an output side, the water heater is connected to a hot water inlet of the mixing valve. The bypass line directly connects the cold water feed to a cold water inlet of the mixing valve. The mixing valve is connected at the output side to the inflow fitting and is configured to provide temperature-controlled water depending on a valve position. A flow element is integrated in the bypass line that at least temporarily at least limits a flow rate through the bypass line.

### BACKGROUND OF INVENTION

### Field of Invention

The invention relates to a system for supplying a regulatable inflow fitting with temperature-controlled water, wherein the system comprises a cold water feed, a water heater, a bypass line and a mixing valve, and wherein at the input side, the water heater is connected to the cold water feed and, at the output side, is connected to a hot water inlet of the mixing valve, and the bypass line directly connects the cold water feed to a cold water inlet of the mixing valve, wherein the mixing valve is connected at the output side to the inflow fitting and is configured to provide temperature-controlled water depending on a valve position.

Moreover, the invention relates to a method to fill a system for supplying a regulatable inflow fitting with temperature-controlled water, wherein the system comprises a cold water feed, a water heater, a bypass line and a mixing valve, and wherein at the input side, the water heater is connected to the cold water feed and, at the output side, is connected to a hot water inlet of the mixing valve, and the bypass line directly connects the cold water feed to a cold water inlet of the mixing valve, wherein the mixing valve is connected at the output side to the inflow fitting and is configured to provide temperature-controlled water depending on a valve position.

### Brief Description of Related Art

Sinks are located in many vehicles, such as railcars, airplanes or touring buses, from which hot water is to be provided. With the assistance of a mixing valve, cold water and hot water are mixed in corresponding proportions so that the desired temperature is provided from a regulatable water tap. The hot water is produced in a water heater, for example in a type of continuous-flow water heater. If the vehicle is turned off and not used for a long time, it is frequently necessary or desirable to completely drain the water, for example to protect from frost or perform service tasks. If the supply system is put into service at a later time, it is necessary for it to be easily refillable, and for the system to subsequently work properly.

### BRIEF SUMMARY OF THE INVENTION

The object of the invention is to present a system for supplying a regulatable inflow fitting that can be filled better. Moreover, an improved method for filling such a system shall be presented. Finally, an improved vehicle with such a system shall be presented.

The object is solved by a system for supplying a regulatable inflow fitting with temperature-controlled water, wherein the system comprises a cold water feed, a water heater, a bypass line and a mixing valve, and wherein at the input side, the water heater is connected to the cold water feed and, at the output side, is connected to a hot water inlet of the mixing valve, and the bypass line directly connects the cold water feed to a cold water inlet of the mixing valve, wherein the mixing valve is connected at the output side to the inflow fitting and is configured to provide temperature-controlled water depending on a valve position, wherein the mixing valve is connected at the output side to the inflow fitting and is configured to provide temperature-controlled water depending on a valve position, wherein the system is developed in that a flow element is integrated in the bypass line that at least temporarily at least limits a flow rate through the bypass line.

The system for supplying a regulatable inflow fitting involves the following technical considerations.

If for example an airplane is shut down for a long time in a cold environment, the water supply system of, for example, a sink is completely drained to prevent frost damage. For refilling, a cold water supply is supplied with water at a given operating pressure. This is done, for example, by turning on a supply pump that is connected at the input side to a cold water supply tank and at the output side to the cold water feed of the water supply system. A short distance after the cold water supply, the system forks into a hot water path and cold water path. The water heater such as a continuous-flow water heater is in the hot water path. The cold water path directly connects the cold water feed to the cold water inlet of the mixing valve.

Due to its design, the water heater has a greater volume than the bypass line forming the cold water path. Consequently, the hot water path has a greater volume than the cold water path. For this reason, when the cold water feed of the system is supplied with cold water, the water level in the cold water path rises faster than in the parallel hot water path. The cold water supply to the system rises through the cold water path up to the inflow fitting, or to a check valve which may be integrated in the system with a flow fluidically parallel to the inflow fitting and serves as a vent valve. The water level that rises quickly through the cold water path causes the filling process to terminate before the water heater is completely filled. In other words, an air bubble of a not insignificant size remains in the water heater at a time at which the system is considered completely filled.

Water heaters such as continuous-flow water heaters are provided with a safety circuit that ensures that the hot water tank which is unfilled, or not up to a level of being at least approximately completely filled, cannot be put into service. This measure prevents the water heater from running dry. If a significant amount of air remains in the water heater, the system for supplying the regulatable inflow fitting as known from the prior art, cannot start.

To avoid this undesirable technical effect, the system according to the invention has a flow element for supplying the regulatable inflow fitting that is integrated in the bypass line, and that limits the flow rate through the bypass line at least temporarily, or at least temporarily blocks the bypass line. By means of this technical measure, the undesirable fast rise of the water level in the cold water path is avoided. The flow element ensures that the water heater is completely filled while filling the system so that the system can then be easily started.

According to an advantageous embodiment, the system is developed in that the flow element is a hydraulically pilot-operated valve that is integrated in the bypass line and is configured to close or open the bypass line, wherein a hydraulic control line is present which connects a connecting line between an outlet of the water heater and the hot water inlet of the mixing valve to a control inlet of the hydraulically pilot-operated valve so that a current pressure in this connecting line can be or is provided as a hydraulic pilot pressure to the hydraulically pilot-operated valve.

In particular, the control line is connected at a connecting point to the connecting line between the outlet of the water heater and the hot water inlet of the mixing valve which is higher geodetically than the outlet of the water heater. This ensures that the control pressure at the hydraulically pilot-operated valve is only applied when the water heater is in fact completely full.

According to the aforementioned exemplary embodiment, a hydraulically pilot-operated valve is installed after the outlet of the water heater. The hydraulically pilot-operated valve is in particular designed so that it is closed when the system is drained. When the system is being filled, the cold water is held back until the water heater is completely filled. The water column rising in the hot water path opens the hydraulically pilot-operated valve in the bypass line. Once the water heater is completely full, the cold water can flow through the open bypass line into the system.

According to another advantageous embodiment, the flow element is a throttle. In particular, a bypass line check valve is integrated in the bypass line parallel to the throttle. This check valve accordingly bridges the throttle.

The throttle integrated in the bypass line ensures that the water column in the cold water path rises more slowly than in the hot water path when filling the system. By correspondingly dimensioning the throttle, the cold water rising speed can be adjusted to always ensure that the hot water heater is completely filled. A bypass line check valve integrated in the bypass line parallel to the throttle makes it easier to drain the system.

According to another advantageous embodiment, the system is developed in that the flow element is a first throttle, wherein a second throttle is integrated in a connecting line between an outlet of the water heater and the hot water inlet of the mixing valve, and wherein a two-pressure valve is included with a first inlet that is fluidically connected via a first control line to the outlet of the water heater, and with a second inlet that is fluidically connected via a second control line to the bypass line, and wherein an outlet of the two-pressure valve is connected to a vent line in which another check valve is integrated. The vent line is for example connected to an outlet of the inflow fitting.

With the two-pressure valve, the inlet of the two-pressure valve is always connected to the outlet of the two-pressure valve where the lowest pressure is applied. This is the inlet that is connected to an air column and not to a water column. The difference in pressure results solely from the different densities of air and water. If one of the two paths (the cold water path or hot water path) is filled with water, the two-pressure valve closes to this path. Consequently, the other path is quickly ventilated through the other inlet to the two-pressure valve and its outlet. The water column does not rise in the path in which the pressure is higher, i.e., the path in which the water column already exists. At an intersection at which the inlet to the two-pressure valve is connected to the hot water or cold water path, a throttle is integrated in both the hot or cold water path. This throttle slows the rise in the water column in the path with the higher pressure. If both the hot water and cold water path are filled with water, at least an approximately identical pressure is at both sides of the two-pressure valve.

All of the throttles can also be designed as throttle valves. All check valves consistently function as drain valves. They are designed so that a ball in the check valve that functions as a seal drops when the line is not full. The air in the line can therefore flow more-or-less unhindered through the check valve in the blocking direction. If a water column is contrastingly at the check valve, the ball in the check valve drops to block the valve. The aforementioned aspects are advantageously applicable to all embodiments.

According to another advantageous embodiment, the system is developed in that a ventilation bypass line connects an inlet of the inflow fitting to an outlet of the inflow fitting, and a check valve is integrated as a vent valve in the ventilation bypass line.

The vent valve makes it easier to drain the system. If the system is opened at the cold water feed, air enters the system at the outlet of the regulatable inflow fitting, i.e., at the head of a water tap. Independent of the position of the mixing valve, this air can flow into the system so that it can be quickly drained through the vent valve.

Moreover, the system is advantageously further developed in that a supply tank for cold water is included which is connected fluidically to the cold water feed by a cold water supply line. In particular, the system also includes a pump that provides the cold water removed from the supply tank to the cold water feed. The pump is for example an electrically operated pump, or for example a battery-operated DC pump.

The regulatable inflow fitting and the mixing valve also form e.g. a regulatable mixing fitting. The regulatable inflow fitting is for example installed in a sink.

According to another advantageous embodiment is it foreseen that the system is completely integrated in a vehicle according to one or more of the aforementioned embodiments. This vehicle is for example a land vehicle, a watercraft or an airplane. The system is for example integrated in an airplane, touring coach, or a rail car in its entirety.

The object is also solved by a vehicle that comprises a system according to one or more of the aforementioned features. This vehicle is for example a land vehicle, a watercraft or an airplane. The vehicle is for example an airplane, touring bus or rail car.

The same or similar advantages as already explained with respect to the system itself apply to the vehicle. The vehicle is for example easier to service since it comprises a supply system that is easy to fill and drain.

The object is furthermore solved by a method for filling a system for supplying a regulatable inflow fitting with temperature-controlled water, wherein the system comprises a cold water feed, a water heater, a bypass line and a mixing valve, and wherein at the input side, the water heater is connected to the cold water feed and, at the output side, is connected to a hot water inlet of the mixing valve, and the bypass line connects the cold water feed to a cold water inlet of the mixing valve, wherein the mixing valve is connected at the output side to the inflow fitting and is configured to provide temperature-controlled water depending on a valve position, wherein the mixing valve is connected at the output side to the inflow fitting and is configured to provide temperature-controlled water depending on a valve position, wherein the method is developed in that a ventilation bypass line connects an inlet of the inflow fitting to an outlet of the inflow fitting, a check valve is integrated as a vent valve in the ventilation bypass line, a flow element is integrated in the bypass line, wherein the system is drained completely at the beginning of the method, and the method comprises the following steps:

Provide cold water at a supply pressure to the cold water feed, limit the flow rate in the bypass line by the flow element, and completely fill the water heater before the cold water flowing through the bypass line reaches the check valve.

The same or similar advantages as already explained with respect to the system for supplying the regulatable inflow fitting also apply to the method. Such a method above all ensures that the water heater is filled completely while the system is being filled so that the system can subsequently be safely and reliably started.

Further features of the invention will become apparent from the description of embodiments according to the invention together with the claims and the included drawings. Embodiments according to the invention can fulfill individual characteristics or a combination of several characteristics.

### BRIEF DESCRIPTION OF THE DRAWINGS

The invention is described below, without restricting the general idea of the invention, based on exemplary embodiments in reference to the drawings, wherein we expressly refer to the drawings with regard to the disclosure of all details according to the invention that are not explained in greater detail in the text. In the following:

FIGS. 1 to 4 schematically portray a simplified system for supplying a regulatable inflow fitting, and

FIG. 5 schematically portrays a simplified vehicle with such a system.

In the drawings, the same or similar types of elements and/or parts are provided with the same reference numbers so that a reintroduction is omitted.

### DETAILED DESCRIPTION OF THE INVENTION

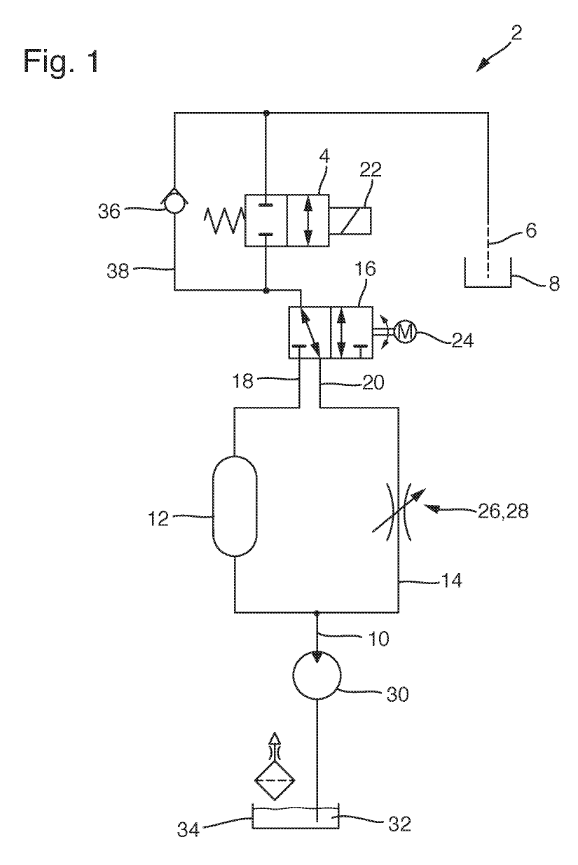

FIG. 1 shows a system 2 for supplying a regulatable inflow fitting 4, such as a water tap, with temperature-controlled water 6. The regulatable inflow fitting 4 is for example attached to a sink 8. The system 2 comprises a cold water feed 10, a water heater 12 such as a continuous-flow water heater or boiler, a bypass line 14 and a mixing valve 16. The mixing valve 16 comprises a hot water inlet 18 and a cold water inlet 20. At the outlet side, the mixing valve 16 is connected to the regulatable inflow fitting 4. The water flow of the temperature-controlled water 6 is regulated or adjusted at a first control element, 22 such as a lever, of the inflow fitting 4. At a second control element 24 such as a lever or rotary wheel, the ratio between hot and cold water is adjusted in the mixing valve 16 so that a desired temperature of the temperature-controlled water 6 can be adjusted. The inflow fitting 4 and the mixing valve 16 can be integrated in a common, regulatable mixing fitting such as a single lever mixing tap.

The water heater 12 is connected at the inlet side to the cold water feed 10 and at the outlet side to the hot water inlet 18 of the mixing valve 16. The bypass line 14 connects the cold water feed 10 directly to the cold water inlet 20 of the mixing valve 16. A hot water path is formed by a fluidic connection that extends from the cold water feed 10 via the water heater 12 up to the hot water inlet 18 of the mixing valve 16. A cold water path is formed by another fluidic connection that extends from the cold water feed 10 via the bypass line 14 up to the cold water inlet 20 of the mixing valve 16.

A flow element 26 is integrated in the bypass line 14 that at least temporarily limits a flow rate through the bypass line 14. The flow element 26 is a throttle valve 28 in the exemplary embodiment depicted in FIG. 1. Likewise, the flow element 26 can also be a permanently set throttle.

The system 2 is for example integrated in a vehicle in its entirety such as an airplane, land vehicle or watercraft. If for example a touring bus, rail car or airplane is shut down for a long time in a cold environment, the water is completely drained from the system 2 to protect against frost. To refill the system 2, the cold water feed 10 is supplied with fresh water 32 at a given operating pressure. A pump 30 is turned on for this purpose, for example. This draws cold fresh water 32 from a supply tank 34 and provides it at a set operating pressure via a cold water supply line to the cold water feed 10.

The water heater 12 such as a continuous-flow water heater is provided with a safety circuit that ensures that the water heater 12 cannot be operated dry. Before the system 2 can be started, the water heater 12 must be completely filled with water. The volume of the hot water path is greater than that of the cold water path. This is because the water heater 12 irrefutably comprises a greater volume than the bypass line 14. When the system 2 is being filled, it must be ensured that the water heater 12 is completely filled before the water level reaches the inflow fitting. In other words, the water level rising quickly through the bypass line 14 and an air bubble remaining in the water heater 12 need to be avoided. The throttle element 26, i.e., the throttle valve 28, is adjusted to ensure that the water level in the bypass line 14 rises slow enough in the process of filling the system 2 for the hot water heater 12 in the hot water path to always be completely filled.

If the water level rises beyond the mixing valve 16 up to the inflow fitting 4, it reaches a check valve 36 that is designed as a vent valve. The check valve 36 is integrated in a ventilation bypass line 38. The ventilation bypass line 38 connects an inlet of the inflow fitting 4 to an outlet of the inflow fitting 4. When ventilating the system 2, air can quickly enter the system 2 through the outlet of the inflow fitting 4 and through the check valve 36 which opens in this case so that the system can be quickly dried.

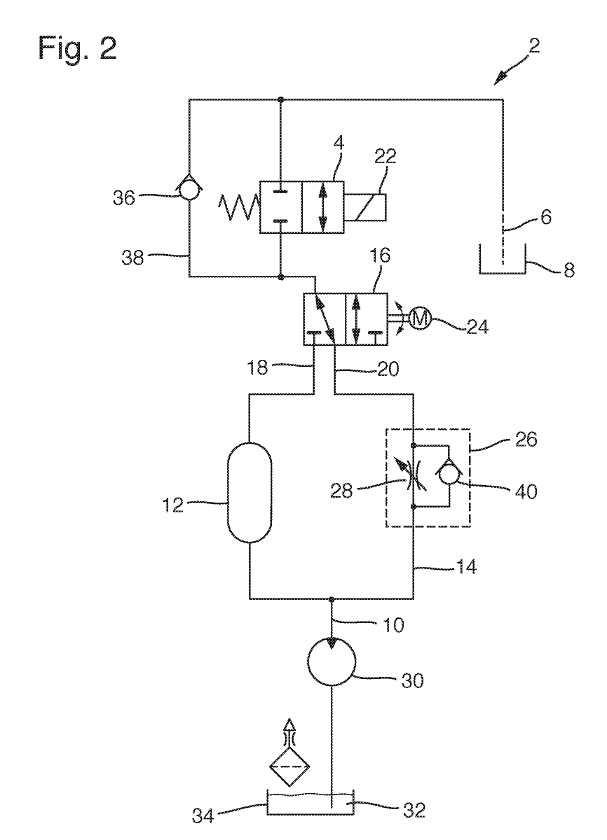

FIG. 2 shows another system 2 for supplying a regulatable inflow fitting 4 that is different from the system 2 from FIG. 1. The flow element 26 is in fact designed as a combination consisting of a throttle valve 28 to which a bypass line check valve 40 is parallel-connected. The bypass line check valve 40 makes it possible to quickly drain the bypass line 14 until the system 2 is drained.

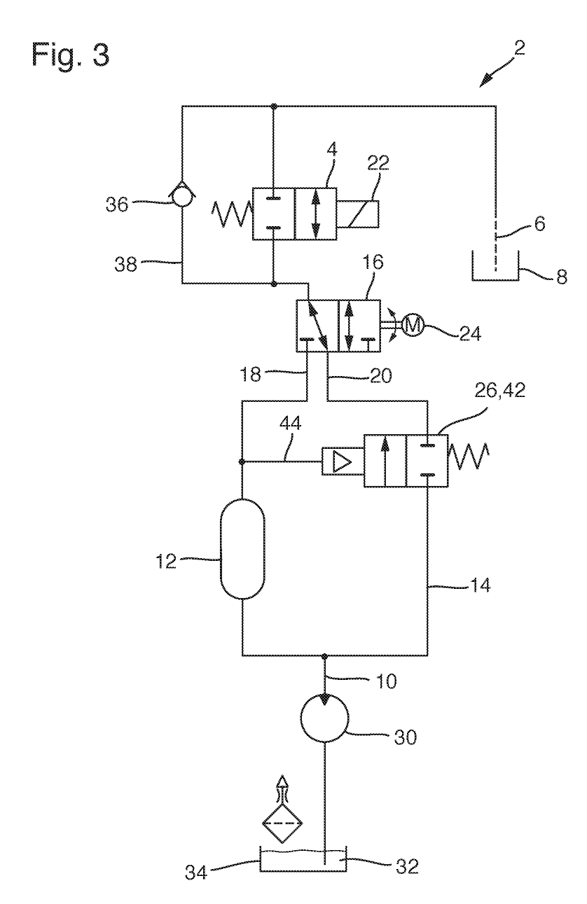

FIG. 3 shows a system 2 for supplying a regulatable inflow fitting 4 with temperature-controlled water 6 according to another exemplary embodiment. This system 2 is also designed similar to the system 2 known from FIG. 1. The exemplary embodiment shown in FIG. 3 has a hydraulically pilot-operated valve 42 as the flow element 26, however.

The hydraulically pilot-operated valve 42 is integrated in the bypass line 14 and is configured to block or open the bypass line 14. A hydraulic control line 44 is connected to the hydraulically pilot-operated valve 42. This is fluidically connected to a connecting line between an outlet of the water heater 12 and the hot water inlet 18 of the mixing valve 16. A current hydraulic pressure in this connecting line is provided as control pressure to the hydraulically pilot-operated valve 42. The hydraulically pilot-operated valve 42 is closed when there is no water in the hydraulic control line 44, i.e., there is only general air pressure or no pressure. When filling the system 2, the water level first rises in the hot water path up to the level of the connecting point between the hydraulic control line 44 and the connecting point between the outlet of the water heater 12 and the hot water inlet 18. If there is a water column in the hydraulic control line 44, the hydraulically pilot-operated valve 42 opens. The bypass line 14 is opened. The cold water path is filled starting from the cold water feed 10. In other words, the cold water path is blocked until the water heater 12 is completely filled.

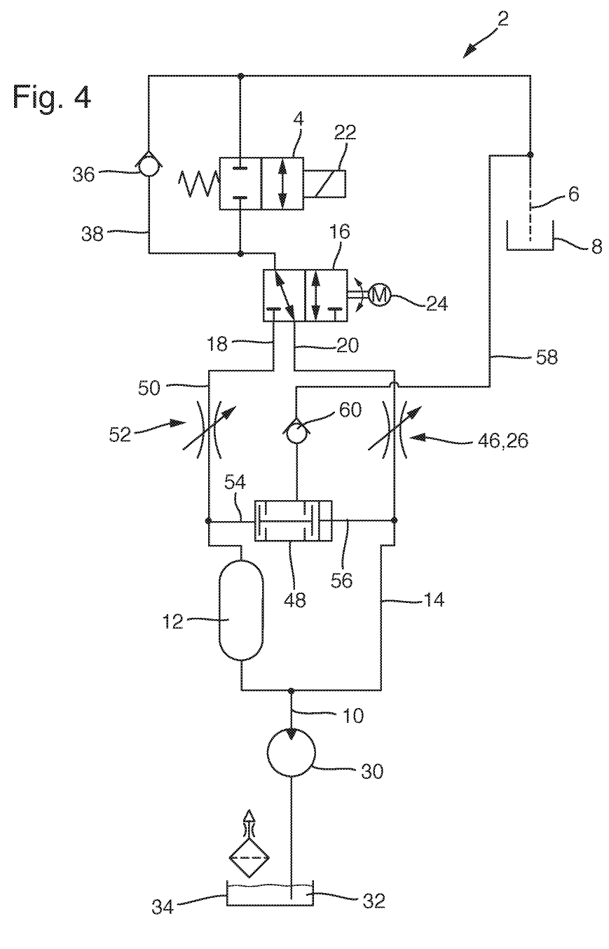

FIG. 4 shows another system 2 for supplying a regulatable inflow fitting 4 with temperature-controlled water 6 according to another exemplary embodiment. The system 2 shown in FIG. 4 comprises a two-pressure valve 48 in addition to a first throttle that is designed as a first throttle valve 46. A second throttle, a second throttle valve 52 according to the depicted exemplary embodiment, is integrated in a connecting line 50 between an outlet of the water heater 12 and the hot water inlet 18 of the mixing valve 16. A first inlet of the two-pressure valve 48 is fluidically connected via a first control line 54 to the outlet of the water heater 12. A the second inlet of the two-pressure valve 48 is fluidically connected via a second control line 56 to the bypass line 14. An outlet of the two pressure valve 48 is connected to a ventilation line 58 in which another check valve 60 is integrated.

The two-pressure valve 48 is designed so that the inlet is connected to the outlet of the two-pressure valve 48 where there is the lower pressure. If the water level rises very quickly in the bypass line 14 up to the first throttle valve 46 when filling the system 2, there is a higher pressure in the second control line 56 than in the first control line 54. The two-pressure valve 48 is open between the first inlet and outlet; correspondingly, the hot water path is quickly ventilated through the first control line 54 and the ventilation line 58. The additional check valve is 60 is open during this process. The filling of the hot water path continues in this manner until the water heater 12 is completely filled, and the water level reaches the additional check valve 60 through the first control line 54 and the outlet of the two-pressure valve 48. The sealing element of said check valve, such as a ball, floats and closes the other check valve 60. During this relatively quickly occurring process, the water level in the cold water path only rises further slightly due to the setting of the first throttle valve 46 so that both the hot-water path and cold water path are completely filled when the water column reaches the check valve 36.

The first throttle valve 46 and the second throttle valve 52 serve to adjust the rise rates of the water column in the hot water path and cold water path as desired to ensure that the water heater 12 is completely filled while filling the system 2.

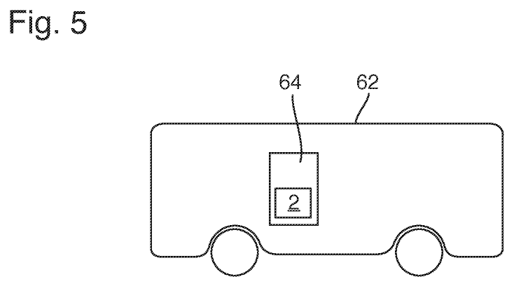

The systems 2 as explained according to the aforementioned exemplary embodiments are for example completely integrated in a vehicle. FIG. 5 shows a schematic and simplified representation of the vehicle 62. A touring bus is schematically indicated as an example which comprises a washroom 64 in which the system 2 is integrated for supplying the regulatable inflow fitting 4. The system 2 supplies a water tap, for example, that is installed on a wash basin in the washroom 64.

In a method for filling the system 2, the system 2 is completely drained at the beginning of the method, as was explained above according to various exemplary embodiments. To fill the system 2, fresh water 32 is provided at a supply pressure to the cold water feed 10, for example, by turning on the pump 30. The flow rate in the bypass line 14 is limited by the flow element 26 so that the water heater 12 is filled completely before the cold water, which is fresh water 32, flowing through the bypass line 14 reaches the check valve 36.

All named features, including those taken from the drawings alone and individual features, which are disclosed in combination with other features, are considered alone and in combination as essential for the invention. Embodiments according to the invention can be fulfilled through individual features or a combination of several features. In the context of the invention, features which are designated with “in particular” or “preferably” are to be understood as optional features.

Reference Number List

| | |
|---|---|
| 2 | System |
| 4 | Inflow fitting |
| 6 | Temperature-controlled water |
| 8 | Washbasin |
| 10 | Cold water feed |
| 12 | Water heater |
| 14 | Bypass line |
| 16 | Mixing valve |
| 18 | Hot water inlet |
| 20 | Cold water inlet |
| 22 | First control element |
| 24 | Second control element |
| 26 | Flow element |
| 28 | Throttle valve |
| 30 | Pump |
| 32 | Fresh water |
| 34 | Supply tank |
| 36 | Check valve |
| 38 | Ventilation bypass line |
| 40 | Bypass line check valve |
| 42 | Hydraulically pilot-operated valve |
| 44 | Hydraulic control line |
| 46 | First throttle valve |
| 48 | Two-pressure valve |
| 50 | Connection line |
| 52 | Second throttle valve |
| 54 | First control line |
| 56 | Second control line |
| 58 | Ventilation line |
| 60 | Additional check valve |
| 62 | Vehicle |
| 64 | Washroom |

What is claimed is:

1. A system for supplying a regulatable inflow fitting with temperature-controlled water, said system comprising:
a cold water feed;
a water heater;
a bypass line; and
a mixing valve;
wherein at an input side, the water heater is connected to the cold water feed and, at an output side, the water heater is connected to a hot water inlet of the mixing valve,
wherein the bypass line directly connects the cold water feed to a cold water inlet of the mixing valve,
wherein the mixing valve is connected at the output side to the inflow fitting and is configured to provide temperature-controlled water depending on a valve position, and
wherein a flow element is integrated in the bypass line that temporarily at least limits a flow rate through the bypass line.

2. The system according to claim 1, wherein the flow element is a hydraulically pilot-operated valve that is integrated in the bypass line and is configured to close or open the bypass line, wherein a hydraulic control line is present which connects a connecting line between an outlet of the water heater and the hot water inlet of the mixing valve to a control inlet of the hydraulically pilot-operated valve so that a current pressure in the connecting line is provided or is providable as a hydraulic pilot pressure to the hydraulically pilot-operated valve.

3. The system according to claim 1, wherein the flow element is a throttle.

4. The system according to claim 3, wherein a bypass line check valve is integrated in the bypass line parallel to the throttle.

5. The system according to claim 1, wherein the flow element is a first throttle, wherein a second throttle is integrated in a connecting line between an outlet of the water heater and the hot water inlet of the mixing valve, wherein a two-pressure valve is included with a first inlet that is fluidically connected via a first control line to the outlet of the water heater, and with a second inlet that is fluidically connected via a second control line to the bypass line, and wherein an outlet of the two-pressure valve is connected to a vent line in which another check valve is integrated.

6. The system according to claim 1, wherein a ventilation bypass line connects an inlet of the inflow fitting to an outlet of the inflow fitting, and wherein a check valve is integrated as a vent valve in the ventilation bypass line.

7. The system according to claim 1, wherein the system further comprises a supply tank for cold fresh water which is fluidically connected to the cold water feed by a cold water supply line.

8. The system according to claim 1, wherein the system is entirely integrated in a vehicle.

9. A vehicle comprising a system according to claim 1.

10. A method for filling a system for supplying a regulatable inflow fitting with temperature-controlled water, wherein the system has a cold water feed, a water heater, a bypass line and a mixing valve, wherein at input side the water heater is connected to the cold water feed, wherein at an output side the water heater is connected to a hot water inlet of the mixing valve, wherein the bypass line connects the cold water feed to a cold water inlet of the mixing valve, wherein the mixing valve is connected at the output side to the inflow fitting and is configured to provide temperature-controlled water depending on a valve position, wherein a ventilation bypass line connects an inlet of the inflow fitting to an outlet of the inflow fitting, wherein a check valve is integrated as a vent valve in the ventilation bypass line, wherein a flow element is integrated in the bypass line, wherein the system is drained completely at the beginning of the method, and wherein the method comprises:
providing fresh water at a supply pressure to the cold water feed;
limiting a flow rate in the bypass line via the flow element; and
completely filling the water heater before cold water flowing through the bypass line reaches the check valve.
